(19) United States
(12) Patent Application Publication
(10) Pub. No.: US 2013/0099617 A1
(43) Pub. Date: Apr. 25, 2013

(54) ELECTRIC MACHINE WITH MAGNET HOLDER

(71) Applicant: Bradley D. Chamberlin, Pendleton, IN (US)

(72) Inventor: Bradley D. Chamberlin, Pendleton, IN (US)

(21) Appl. No.: 13/279,963

(22) Filed: Oct. 24, 2011

(51) Int. Cl. H02K 1/28

(52) U.S. Cl. 310/156.21; 310/156.08

(57) ABSTRACT

An electric machine having a rotor with an axially extending magnet slot. A magnetic material is mounted in a magnet holder to form a magnet holder assembly which is installed in the magnet slot of the rotor. In some embodiments, the magnet holder assembly substantially fills the entire slot volume. In other embodiments, the magnet holder assembly defines a greater thickness of dielectric material between the magnetic material and the major side of the slot nearest the stator than between the magnetic material and the opposite side of the slot. In still other embodiments, a plurality of axially abutting magnet holder assemblies are installed in the magnet slot. In yet other embodiments, the magnet holder comprises two materials with different durometer values wherein one of the materials is resiliently, compressibly engaged with the slot to secure the magnet holder assembly therein. A method of manufacture is also disclosed.

### BACKGROUND OF THE INVENTION

The present invention relates to electric machines and more particularly to internal permanent magnet electric machines.

The two main components of an electric machine are the stator and the rotor. While there are several different types of electric machines, one common type has a rotor with permanent magnets. Such permanent magnet electric machines can be operated as a motor to convert electrical power into mechanical power or as a generator to convert mechanical power into electrical power.

In some applications, the electric machine may be operated exclusively as a motor while in other applications the electric machine may be operated exclusively as a generator. In still other applications, such permanent magnet electrical machines may be selectively operated as either a motor or as a generator. When an electric machine can function as both a motor and a generator in both rotational directions, it is commonly referred to as a four quadrant operating electrical machine.

Internal permanent magnet electrical machines have a wide variety of uses. For example, such motors may be employed in hybrid electric vehicles and can be operated as a generator when the vehicle is braking and as a motor when the vehicle is accelerating. Other applications may employ such electrical machines exclusively as motors, for example, as motors which power different components of construction and agricultural machines. Other uses may employ such motors exclusively as a generator such as in a portable generator for residential use. Those having ordinary skill in the art will recognize that internal permanent magnet electrical machines can also be utilized in a large and varied number of applications beyond those few mentioned here.

The rotors of such electrical machines are commonly manufactured by stamping and stacking a large number of sheet metal laminations. In one common form, these rotors are provided with axially extending slots for receiving the permanent magnets. These magnet slots are typically located near the rotor surface facing the stator. Motor efficiency is generally improved by minimizing the distance between the rotor magnets and the stator. When the magnet slots are located very close to the rotor exterior to maximize motor efficiency, only a thin bridge of material formed by the stacked laminations of the rotor separates the magnet slots from the exterior surface of the rotor.

Various methods have been used to install permanent magnets in the magnet slots of the rotor. These methods may either leave a void space within the magnet slot after installation of the magnet or completely fill the magnet slot. As explained below, leaving a void space within the slot can have a negative impact on the operation of the electric machine while the thin bridge of rotor material adjacent the magnet slot complicates those methods which completely fill the magnet slot.

One of the simplest methods of installing a permanent magnet in a rotor is to simply slide the magnet into the slot and retain the magnet within the slot by a press-fit engagement between the slot and the magnet. This type of installation will typically result in axially extending void spaces located at opposite lateral ends of the magnet. If the electric machine is an oil cooled machine where oil is splashed on the rotor, the oil may collect in the void spaces in the magnet slots of the rotor. The collection of oil in the void spaces of the rotor is undesirable because it can lead to the unbalancing of the rotor.

Other methods of installing permanent magnets in the slots are known which do not result in any void spaces within the slot. For example, an adhesive or resinous material can be injected into the void spaces of the slot to completely fill the slot and securely hold the magnet within the slot. In other methods, magnetic material may be combined with a resinous material with this combination of materials being injected into the entirety of the slot.

While these methods can effectively eliminate the void spaces within the magnet slots, they are not without their own drawbacks. For example, using an injection molding process to introduce a material into the slot at a high pressure and temperature can cause the thin bridge of rotor material separating the slot from the exterior surface of the rotor to blow out or bulge. It is possible to avoid damage to the bridge material by closely controlling the quantity of injected material and the temperature and pressure at which the material is injected. The exercise of such tight controls on the manufacturing process, however, results in higher costs of manufacture.

Improvements in the design of permanent magnet electric machines and in processes for manufacturing such machines remain desirable.

### SUMMARY OF THE INVENTION

The present invention provides a magnet holder in which a permanent magnet can be positioned before the permanent magnet and magnet holder are installed in a magnet slot to thereby provide a more easily manufactured permanent magnet electric machine.

The invention comprises, in one form thereof, an electric machine that includes a stator and a rotor operably coupled with the stator. The rotor defines a body rotatable about an axis and has at least one axially extending slot. The at least one slot defines a slot volume. The electric machine also includes a magnetic material which forms at least one magnet body and at least one magnet holder. The magnet body is mounted within the magnet holder to form a magnet holder assembly and the magnet holder assembly is disposed within the slot and substantially fills the entire slot volume.

The invention comprises, in another form thereof, an electric machine that includes a stator and a rotor operably coupled with the stator. The rotor defines a body rotatable about an axis and has at least one axially extending slot which defines an axial length of the slot. The rotor body circumscribes a substantial majority of the slot in a plane oriented perpendicular to the axis over substantially the entire axial length of the slot. The slot defines an elongate opening with two opposing major sides wherein the two opposing major sides define a first side relatively proximal, i.e., nearer, the stator and a second side relatively distal, i.e., distant, the stator. The electric machine also includes a magnetic material that forms at least one magnet body and at least one magnet holder. The magnet body is mounted within said magnet holder to form a magnet holder assembly. The magnet holder assembly is disposed within the slot with the magnet holder assembly defining a greater thickness of dielectric material between the magnetic material and one of the first and second sides of the slot than between the magnetic material and the other of the first and second sides of the slot.

The invention comprises, in yet another form thereof, an electric machine that includes a stator and a rotor operably coupled with the stator. The rotor defines a body rotatable about an axis and has at least one axially extending slot that defines an axial length of the slot. The rotor body circumscribes a substantial majority of the slot in a plane oriented perpendicular to the axis over substantially the entire axial length of the slot. The electric machine also includes a plurality of magnet holders and a magnetic material forming at least one magnet body. At least a portion of the magnet body is mounted within each one of the plurality of magnet holders to form a plurality of magnet holder assemblies. Each of the at least one slots has a plurality of the magnet holder assemblies disposed therein.

The invention comprises, in still another form thereof, an electric machine that includes a stator and a rotor operably coupled with the stator. The rotor defines a body rotatable about an axis and which has at least one axially extending slot. The electric machine also includes a magnetic material forming at least one magnet body and at least one magnet holder wherein the magnetic material is mounted within the magnet holder to form a magnet holder assembly. The magnet holder is formed of first and second materials. The second material defines at least a portion of an exterior surface of the magnet holder assembly and is a resiliently compressible material having a lower durometer value than the first material. The second material is compressibly engaged by an interior surface of the slot to secure the magnet holder assembly within the slot.

The invention comprises, in still another form thereof, a method of assembling electrical machines. The method includes providing a first stator and a first rotor to manufacture a first electrical machine having a first axial length and providing a second stator and a second rotor to manufacture a second electrical machine having a second axial length greater than the first axial length wherein the first and second rotors have a substantially common cross sectional configuration defining at least one commonly shaped slot extending the axial length of the first and second rotors. The method also includes providing a plurality of first magnet holders each having at least one magnet body mounted therein to form a plurality of first magnet holder assemblies wherein each of the first magnet holder assemblies has a common configuration. At least one of the first magnet holder assemblies is installed in the commonly shaped slot of the first rotor and the second rotor. The method further includes providing at least one second magnet holder having at least one magnet body mounted therein to form a second magnet holder assembly and installing the second magnet holder assembly in the commonly shaped slot of the second rotor.

In such a method, the second magnet holder assembly may have the same configuration as the first magnet holder assemblies. Alternatively, the second magnet holder assembly may have a different configuration than the first magnet holder assemblies with the magnet holder assemblies disposed within the commonly shaped slot of the second rotor each defining opposing axial end surfaces wherein, at opposite axial ends of the second rotor body, the axial end surfaces define magnet holder end walls that substantially cover axial end surfaces of the magnet bodies and wherein each of the axial end surfaces of the magnet holder assemblies that are in axial abutment with one of the axial end surfaces of another one of the magnet holder assemblies within the commonly shaped slot of the second rotor is at least partially defined by the magnet bodies.

In still other variants of this method, at least three magnet holder assemblies are installed in the commonly shaped slot of the second rotor and at least two magnet holder assemblies are installed in the commonly shaped slot of the first rotor. The magnet holder assemblies disposed within the commonly shaped slot of the first rotor each define opposing axial end surfaces with the axial end surfaces located at opposite axial ends of the first rotor defining magnet holder end walls that substantially cover axial end surfaces of the magnet bodies and wherein each of the axial end surfaces of the magnet holder assemblies that are in axial abutment with one of the axial end surfaces of another one of the magnet holder assemblies within the commonly shaped slot of the first rotor are at least partially defined by the magnet bodies.

### BRIEF DESCRIPTION OF THE DRAWINGS

The above mentioned and other features of this invention, and the manner of attaining them, will become more apparent and the invention itself will be better understood by reference to the following description of embodiments of the invention taken in conjunction with the accompanying drawings, wherein:

FIG. 1A is a schematic cross sectional view of an electric machine.

FIG. 1B is a partial view of the electric machine of FIG. 1A.

FIG. 1C is a partial view of an alternative electric machine.

FIG. 2 is a partial exploded perspective view showing magnet slots, magnet holders and magnets.

FIG. 3 is a perspective view of two magnet holders having open ends.

FIG. 4 is a perspective view of two magnet holders having closed ends.

FIG. 5 is an enlarged perspective view of magnet holders having closed ends.

FIG. 6 is a top view of a magnet holder with magnets positioned therein.

FIG. 7 is a cross sectional view taken along line 7-7 of FIG. 6.

FIG. 8 is an end view of two magnet holders having closed ends.

FIG. 9 is an exploded perspective view of a magnet and an alternative magnet holder.

FIG. 10 is a perspective view of two of the magnet holders of FIG. 9 with magnets positioned therein.

FIG. 11 is an exploded side view of two rotors having different axial lengths.

Corresponding reference characters indicate corresponding parts throughout the several views. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION OF THE INVENTION

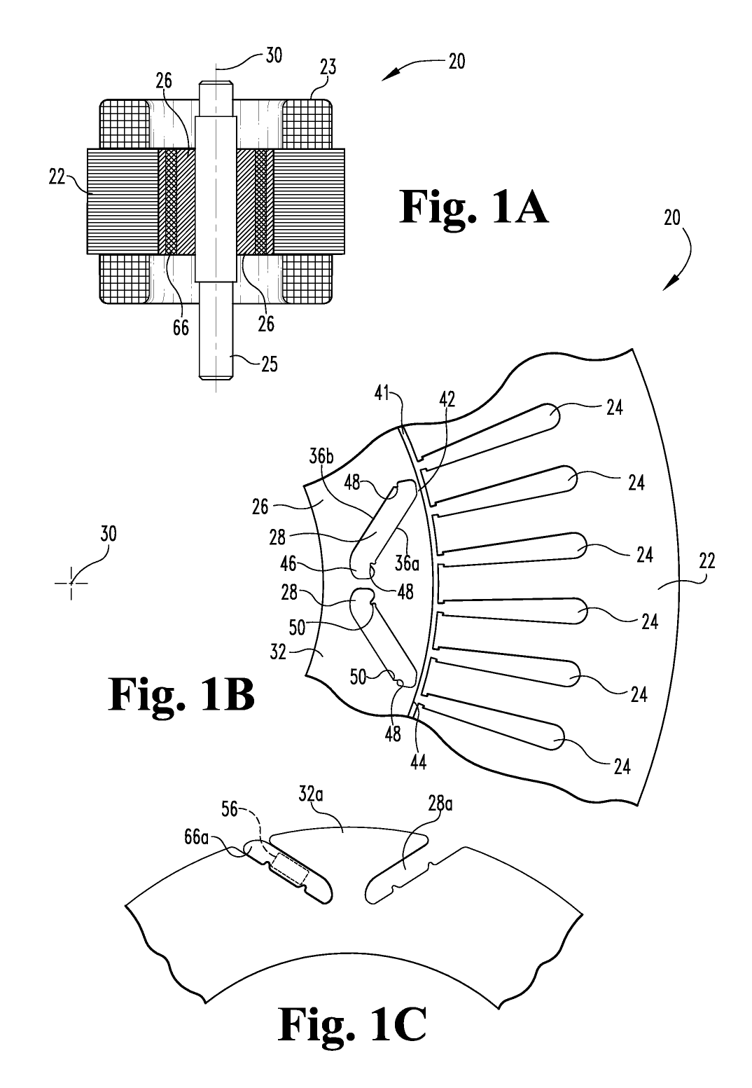

One embodiment of an electric machine 20 in accordance with the present invention is illustrated in FIGS. 1A and 1B. The electric machine 20 includes a stator 22 with winding slots 24. Winding slots 24 have windings 23 (shown only in FIG. 1A) mounted therein. The windings are generally formed out of copper wire and are often referred to as magnet wire. Electric machine 20 also includes a rotor 26 having magnet slots 28. A shaft 25 is often mounted within rotor 26 as depicted in FIG. 1. As discussed in greater detail below, permanent magnets are mounted within slots 28.

The stator 22 and rotor 26 are operably coupled together to form an electric machine 20 which may be operated as a motor to convert electrical energy into mechanical energy or as a generator to convert mechanical energy into electrical energy. In some applications the electrical machine 20 may be used exclusively as a motor, in others it may be used exclusively to generate electricity while in still others it may be used to selectively operate as both a motor and a generator. The principles underlying the operation of electrical machines as motors, generators and both motors and generators is well known to those having ordinary skill in the art.

As will be recognized by those having ordinary skill in the art, rotor 26 rotates about an axis 30 while stator 22 remains stationary. Although electrical machines typically employ rotors which are centrally disposed within the stator, it is also possible for electrical machines to employ a centrally located stator with a rotor that surrounds the stator. FIG. 1 illustrates only a small angular segment of the stator 22 and rotor 24 which extend 360 degrees about axis 30. Those portions of stator 22 and rotor 24 which are not illustrated in FIG. 1 have the same configuration as that segment which is illustrated.

The body 32 of the illustrated rotor 26 is formed out of a stack of sheet metal laminations. Stator 22 is also formed out of a stack of sheet metal laminations. While the use of such stacked laminations is commonly employed in the manufacture of stators and rotors, other materials and methods of assembly may also be used to form the body of the stator 22 and rotor 26. Slots 28 extend through rotor body 32 and define opposed openings 34 at opposite axial ends 29 of slot 28. Slots 28 of the rotor illustrated in FIG. 1B are fully circumscribed by the rotor body 32 in planes oriented perpendicular to axis 30 over the entire axial length of slot 28.

While the slots 28 illustrated in FIG. 1B are fully circumscribed by rotor body 32, alternative embodiments of the present invention can also be used. For example, in some embodiments, the rotor body may circumscribe a substantial majority of the slot but not entirely circumscribe the slot. One example of a slot 28a which has a substantial majority of the slot 28a circumscribed by rotor body 32a is depicted in FIG. 1C. In this figure, one edge of the slots 28a extends to the outer radial perimeter of the rotor and forms an axially extending gap on the rotor. In FIG. 1C, a magnet holder assembly 66a holding at least one magnet body 56 which fills substantially the entire volume of slot 28a is shown in the slot 28a on the left side of the figure while the slot 28a on the right side of the figure is depicted without any object therein.

As can be seen in the figures, the openings 34 defined by slots 28 are elongate openings with two major opposing sides 36a, 36b and two opposing edges 38 extending between the two major sides 36a, 36b. The first major side 36a of slot 28 is disposed relatively proximal stator 22 while the second major side 36b is disposed relatively distal stator 22. In other words, first major side 36a is located nearer stator 22 than is the second major side 36b. The efficiency of electrical machine 20 is generally enhanced by minimizing the distance between stator 22 and the magnetic material 40 located within slot 28. Minimizing the distance between stator 22 and magnetic material 40 also generally corresponds to maximizing the radial distance between the magnetic material 40 and axis 30. Maximizing this radial distance enhances the torque that can be generated by electrical machine 20. These distances are dependent on a number of factors, including the distance between stator 22 and slot 28 and the position of magnetic material 40 within slot 28.

The distance between stator 22 and slot 28 is, in turn, dependent upon several factors, such as the size of the air gap 41 between rotor 26 and stator 22 and the placement of slots 28 relative to the outer circumference 44 of rotor 26. The placement of slots 28 on rotor 26 depends, in part, on the minimum width of material bridge 42 required for structural integrity and functionality of rotor 26. Material bridge 42 is that part of rotor body 32 disposed between the outer circumference 44 of rotor 26 and that portion of slot 28 nearest the outer circumference 44. By eliminating the step of injection molding a filler material into slot 28 and replacing this step by the sliding introduction of a magnet holder assembly into slot 28, the forces that material bridge 42 must resist during assembly of rotor 26 are reduced. In some rotor designs this will allow the size of material bridge 42 to be reduced when employing these teachings. This will allow for the positioning of slot 28 at a greater radial distance from axis 30 and closer to stator 22.

As mentioned above, the position of magnetic material 40 within slot 28 is also a factor in determining the distance between magnetic material 40 and both the stator 22 and axis 30. Minimizing the thickness of dielectric material between magnetic material 40 and the first side 36a of slot 28 enhances the efficient operation and torque generating capacity of electrical machine 20. As discussed in greater detail below, some embodiments of the present invention utilize a minimal thickness of dielectric material between magnetic material 40 and the first side 36a of slot 28 to enhance the functional attributes of electrical machine 20 by directly engaging magnet body 56 with side 36a of slot 28.

Returning again to the geometry of slots 28, the end regions 46 proximate opposite edges 38 do not include magnetic material 40 and have a shape that influences the magnetic field as is known to those having ordinary skill in the art. Projecting into each of the opposite end regions 46 are axially extending stops 48. Stops 48 define registry surfaces 50 which extend the full axial length of slot 28 and which face the far edge 38. As discussed below, magnet holders 60 include a pair of axially extending registry surfaces 52 which each engage one of the pair of registry surfaces 50 when inserting the magnet holder 60 into slot 28 to thereby control the position of magnet holder 60 within slot 28. Magnet holders 60 also define enlarged end regions 47 which fill the end regions 46 of slots 28. As a result end regions 46 of slots 28 are filled with the dielectric material forming the enlarged end regions 47 of magnet holders 60 without any magnetic material 40 being positioned in end regions 46. As can be seen in the figures, end regions 47 of magnet holders 60 have a thickness which is greater than end walls 64 and other walls and partitioning elements of magnet holders 60.

Turning now to the contents of slot 28, a magnetic material 40 is installed in the slots 28 using magnet holders 60. Magnetic material 40 is a material capable of acting as a permanent magnet within rotor 26. Magnetic material 40 may be magnetized when installed or may be non-magnetized when installed in magnet holders 60 and have magnetic properties imparted to it during the manufacture of the electrical machine 20. The magnetic material 40 may be neodymium iron boron. Dysprosium may be used with the magnetic material to provide greater temperature stability and allow the magnetic material to better resist the loss of magnetism. A variety of other materials may also be used to form magnetic material 40 including rare earth materials such as lithium, terbium and samarium. The use of these and other such magnetic materials with internal permanent magnet electric machines is well-known to those having ordinary skill in the art.

In the illustrated embodiments, the magnetic material 40 is provided with an outer layer of material 54 to form magnet bodies 56. The use of an outer coating can be used to enhance resistance to corrosion. This outer covering 54 may be formed out of a variety of materials. For example, a layer of nickel can be formed on the magnetic material by electroplating or a layer of aluminum can formed by vapor diffusion. The outer layer 54 may also be formed out of a dielectric material. For example, an inorganic epoxy coating can be applied to the magnetic material 40 to form a dielectric outer layer 54. The use of a dielectric material to form outer coating 54 prevents shorting across the laminations forming rotor body 32 through magnetic material 40. While the use of a dielectric outer coating to prevent such shorting can improve the efficiency of the electric machine, it is thought that in most applications the potential improvement in efficiency by the use of such a dielectric coating is negligible. FIG. 7 illustrates the external layer of outer coating 54 but is not meant to accurately reflect the actual thickness of outer coating 54.

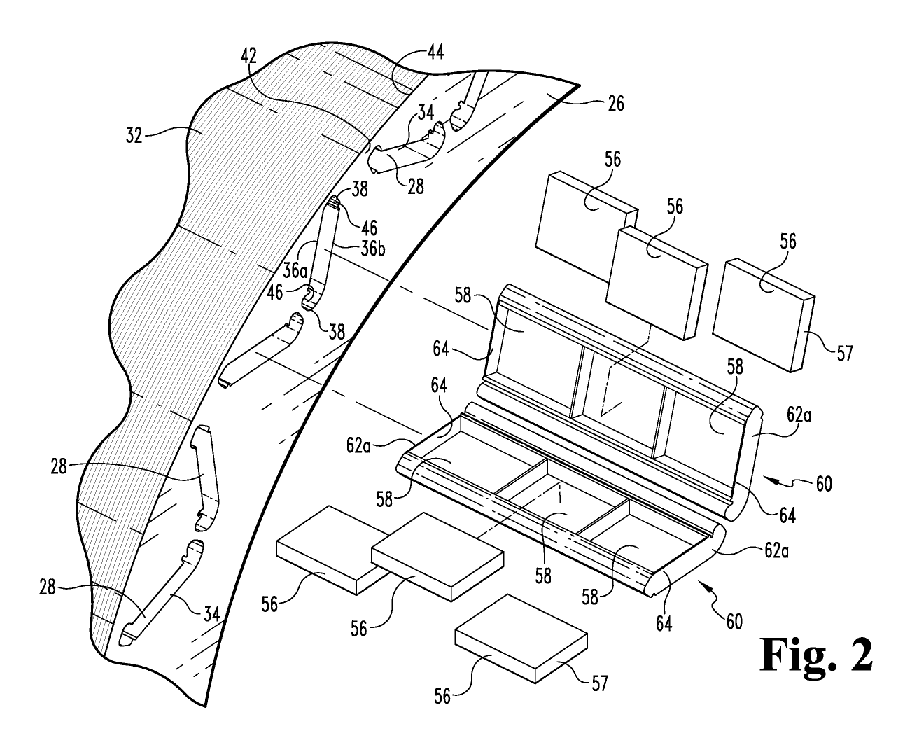

Magnet bodies 56 are mounted in magnet holders 60 to form magnet holder assemblies 66 which are, in turn, installed in slots 28. In the embodiment illustrated in FIG. 2, magnet holders 60 each include three separate compartments 58 for receiving magnet bodies 56. Magnet bodies 56 can be adhesively secured to magnet holders 60 although it will generally be preferable if magnet bodies 56 are retained in magnet holders 60 by frictional resistance to removal. For example, magnet bodies 56 may be sized for a slight interference fit with compartments 58 to thereby retain magnet bodies 56 in magnet holder 60 as best understood with reference to FIG. 7.

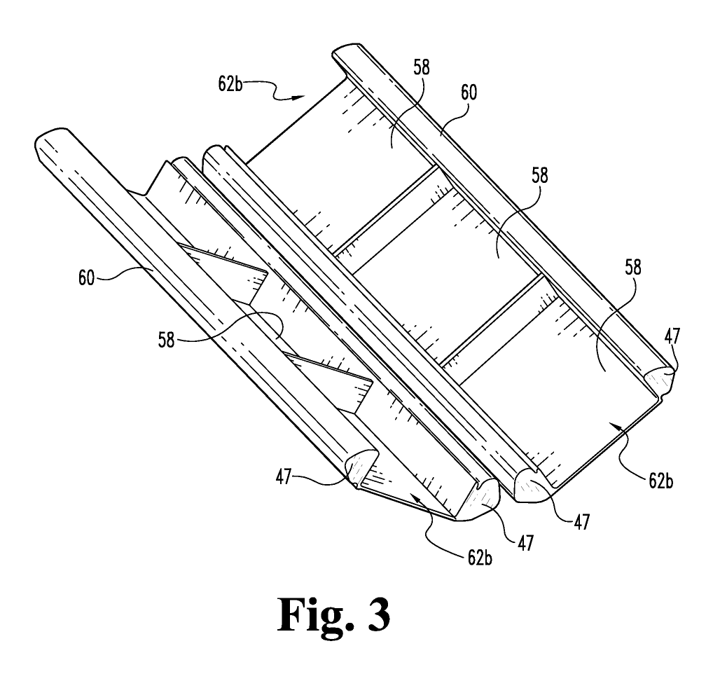

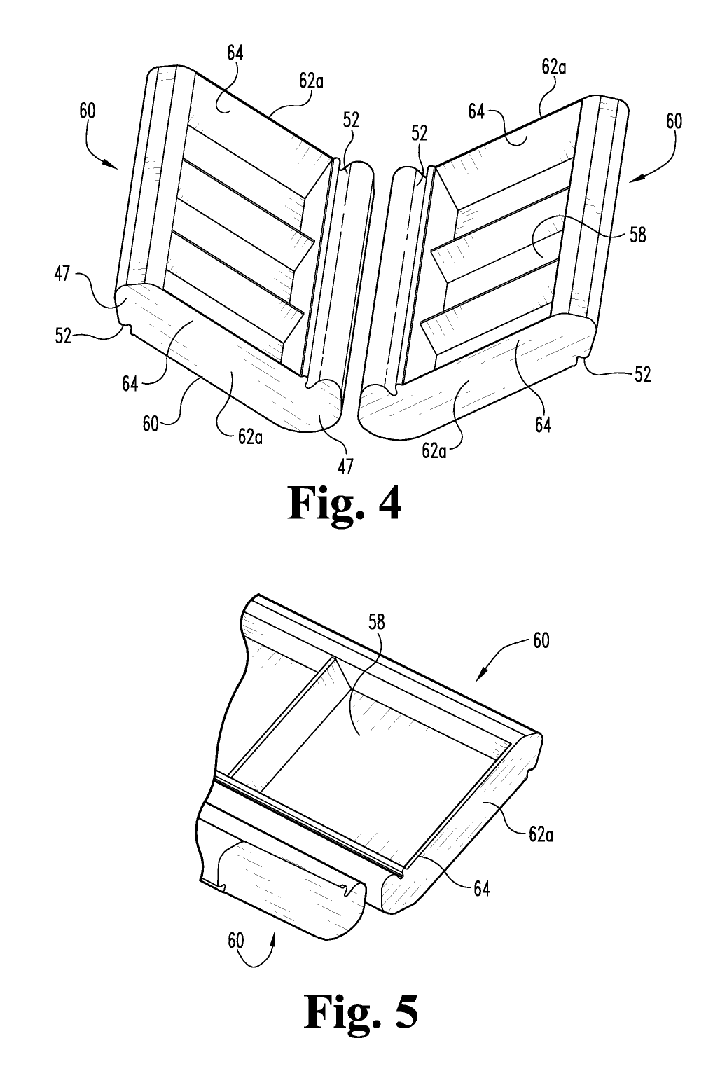

The axial ends of magnet holders 60 may have either an open or closed configuration. For example, the magnet holders 60 depicted in FIG. 2 have closed axial ends 62a while the magnet holders 60 depicted in FIG. 3 have open axial ends 62b. Closed axial ends 62a (FIG. 2) have an end wall 64 which covers the axial end surface 57 of the magnet body 56 immediately adjacent end wall 64. In contrast, open axial ends 62b (FIG. 3) do not include end walls 64 and leave the axial end surface 57 of magnet body 56 exposed at the open axial end 62b.

The use of a closed axial end 62a can be particularly advantageous when the closed end 62a is disposed at the axial end 29 of a slot 28 such that the end wall 64 defines a portion of the exposed axial surface of the rotor 26. The end wall 64 thereby covers the axial end surface 57 of magnet body 56 and provides protection against chipping and other potential damage. End wall 64 also more firmly secures the adjacent magnet body 56 within holder 60. It will oftentimes be desirable to insert only a single magnet holder assembly 66 into each slot 28 for purposes of manufacturing efficiency. In such instances, a magnet holder 60 having two closed ends 62a, as depicted in FIGS. 2 and 4, will generally be preferred due to the protection and enhanced securement of the magnet bodies 56 afforded by end walls 64.

The use of open axial ends 62b can be advantageous when a plurality of magnet holders 60 are positioned end-to-end, i.e., in an axially abutting arrangement, within a single slot 28. In such cases, the axial end surfaces 62b of the magnet holder assemblies 60 that are in axial abutment with one of the axial end surfaces 62b of another one of the magnet holder assemblies 60 are at least partially defined by the magnet body 56. In such an arrangement, the placement of two open axial ends 62b together allows for an increased volume of magnetic material 40 within slot 28.

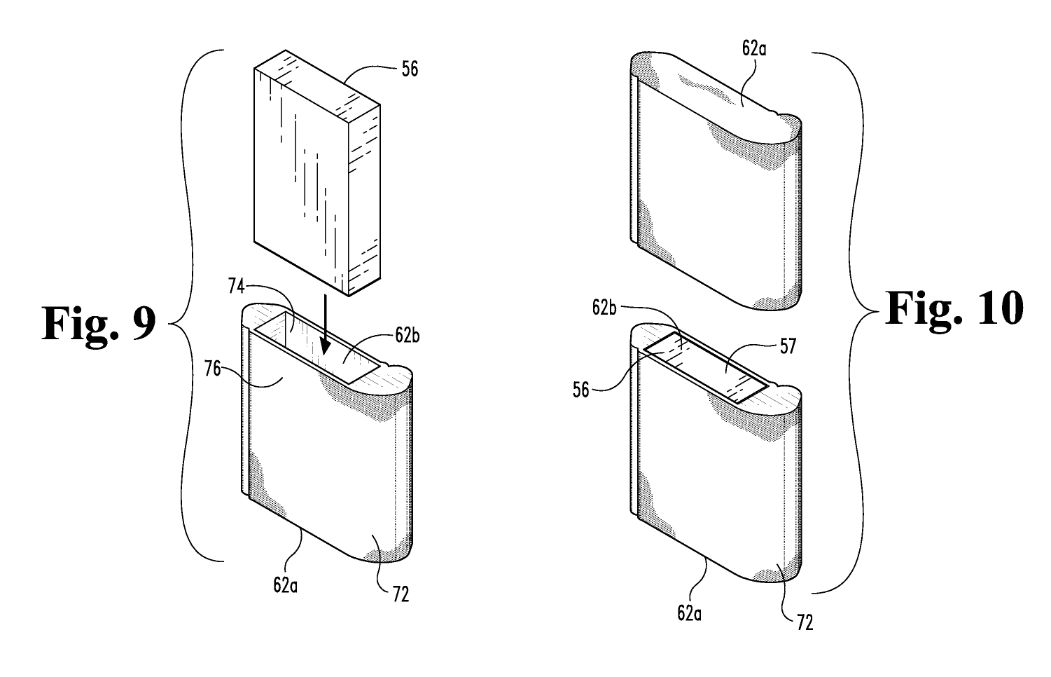

While the magnet holders depicted in FIGS. 2 and 3 have opposing axial ends with the same configuration, it can also be desirable to provide a magnet holder having one closed axial end 62a and one open axial end 62b. This allows the closed end 62a to be positioned at the axial end 29 of the slot 28 while the open end 62b to be positioned adjacent another magnet holder 60 disposed within the slot 60. FIGS. 9 and 10 illustrate magnet holders having one closed end 62a and one open 62b.

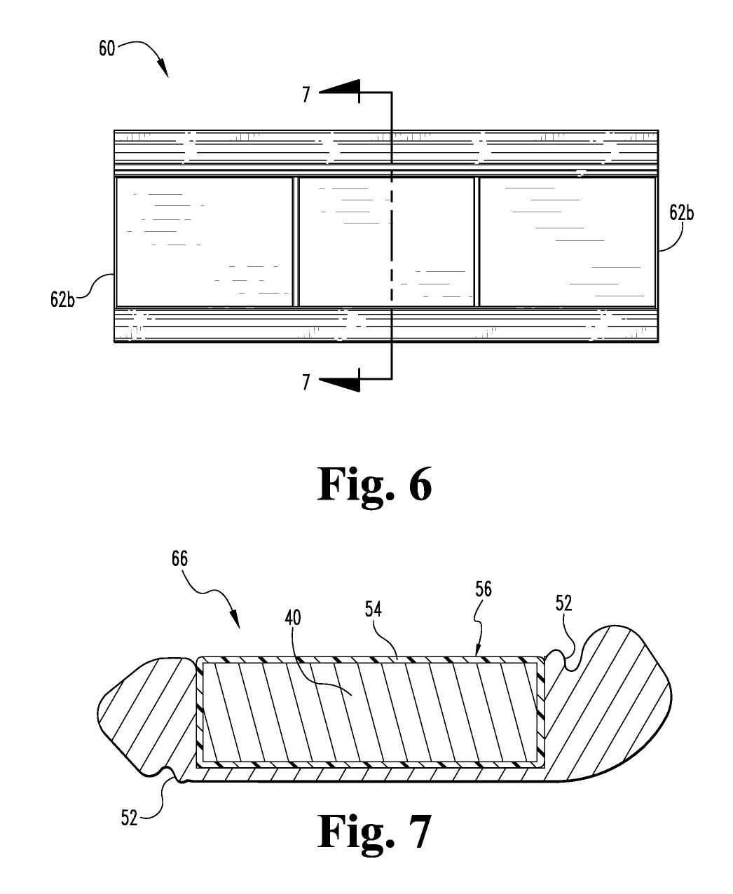

Returning to the magnet holders 60 depicted in FIGS. 2-7, these magnet holders each define a plurality of discrete compartments 58 for receiving magnet bodies 56. The aspect ratio of the magnetic material 40, i.e., its length vs. width ratio, can influence the ease with which the material can be handled. For example, if the length of magnetic material 40 becomes excessive compared to its width, i.e., a long and skinny magnet body, it becomes more easily broken. Thus, electric machines manufactured using shorter magnet bodies 56 can generally be manufactured with less waste due to breakage. On the downside, the use of shorter magnet bodies 56 increases the number of parts that must be used and can thereby drive up costs. Still another factor determining the size of compartments 56 and the number of and axial extent of the walls separating compartments 56 is the desired total volume of magnetic material 40 within a particular slot 28. The axial length of compartments 58 and the number and thickness of the separating walls are all selected based upon such factors. The ability to choose between closed 62a and open 62b axial ends, provides the designer greater flexibility when making such design choices.

As mentioned above, slot 28 has an axial length and a cross sectional shape that defines openings 34 which, in turn, determine the slot volume. Magnet holder assemblies 66 are configured to fill the entire volume of slot 28. This prevents oil from collecting in a void space within slot 28 and thereby also prevents such collected oil from causing imbalances in the rotor 26. Magnet holder assemblies 66 are advantageously secured within slots 28 by a slight interference fit whereby the magnet holder assemblies 66 are non-adhesively secured within slot 28 by frictional engagement with the rotor body 32 defining slot 28. It remains an option, however, to use an adhesive, or other suitable securement means known to those having ordinary skill in the art, when securing magnet holder assemblies 66 within slot 28.

The typical temperature range of an electric machine 20 may range from a high of 180° C. to a low of −40° C. or −50° C. The materials used to form magnet holder 60 will need to function properly throughout the anticipated operating range. It is also advantageous to form magnet holders 60 out of a dielectric material. Nylon materials are available which are dielectric and will properly function throughout this operating range. Magnet holders 60 can be formed by injection molding processes.

As mentioned above, magnet holders 60 are configured such that the resulting magnet holder assembly 66 completely fills the volume of slot 28. As a result, the dielectric material used to form magnet holders 60 fills the end regions 46 of slots 28. The magnet holders 60 also define axially extending registry surfaces 52 which engage registry surfaces 50 on stops 48 within end regions 46. The registry of surfaces 50 and 52 controllably positions magnet holders 60, and thus magnet bodies 56, within slot 28. The use of stops 48 such as those shown in the figures is also used in prior art methods which involve installing magnet bodies 56 directly in slots 28 and then injection molding a filler material directly into slot 28 about magnet bodies 56. When installing magnet holder assemblies 66 into rotors 26 designed for the direct insertion of magnet bodies, the magnet holders 60 can be configured to take advantage of the registry surfaces 52. The location of such registry surfaces, however, can advantageously be moved to the edges 38 of slot 28 in a rotor 26 designed for use with magnet holder assemblies as described herein and thereby provide for the elimination of inwardly projecting stop 48. The elimination of stop 48 would allow for less complex lamination stampings which, in turn, can reduce manufacturing costs.

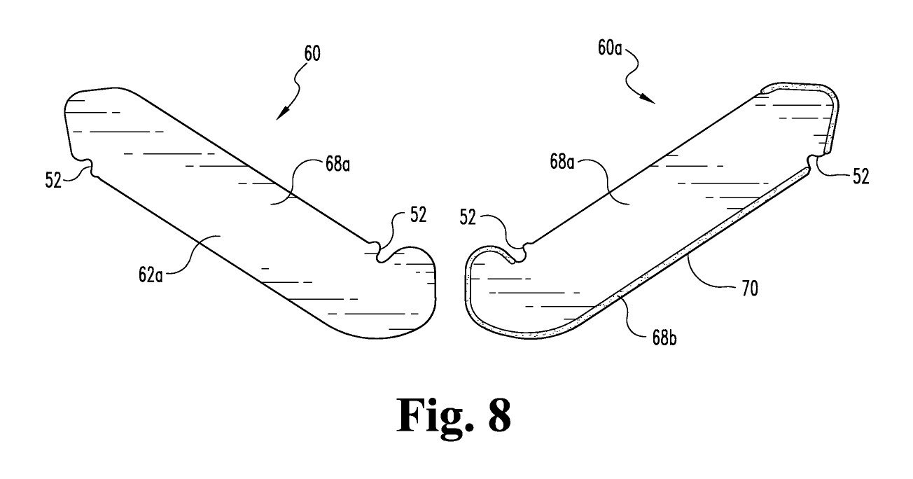

Turning now to FIG. 8, end views of two magnet holders 60, 60a are shown. Both of the magnet holders depicted in FIG. 8 have closed ends and magnet holder 60 is formed out of a single material 68a. The second magnet holder 60a depicted in FIG. 8 is formed out of two materials with the main body of magnet holder 60a being formed out of a material 68a such as that used to form the entirety of magnet holder 60. The second material 68b is a resiliently compressible material having a lower durometer value than the first material 68a. In other words, the second material 68b is more easily compressed than the first material 68a. An exterior layer of material 68b is formed about a selected portion of magnet holder 60a so that a selected portion of the exterior surface 70 is formed by the more easily compressed material 68b.

When magnet holder 60a is inserted into a slot 28, the more easily compressed material 68b engages the interior surface of slot 28, e.g., side 36b and edges 38, and closely conforms to these surfaces as it is compressed. The use of such a compressible material can enhance the securement of magnet holder 60a within slot 28. It may also allow for the use of looser tolerances in the manufacture of magnet holder 60a. As can be seen in FIG. 8, the registry surfaces 52 located on magnet holder 60a which are used to control the position of magnet holder 60a are formed out of the less easily compressed material 68a. The less easily compressed material 68a also directly engages the magnet bodies 56 and forms a substantial majority of the magnet holder 60a whereby material 68a controls the positions of magnet bodies 56 by direct engagement of both slot 28 and magnet bodies 56.

Turning now to FIGS. 9 and 10, alternative magnet holders 72 are shown. Unlike magnet holders 60 in which the magnet material 40 is laterally inserted into axially separated compartments 58, magnet holders 72 form a pocket with a single opening 74 through which the magnetic material is introduced into magnet holders 72. FIG. 9 provides an exploded schematic representation showing how magnet body 56 can be introduced through opening 74 into magnet holder 72.

An advantage provided by a magnet holder such as those depicted in FIGS. 9 and 10 which form a sleeve-like structure with one closed end 62a and one open end 62b is that such structures are potentially manufacturable using a blow-molding process in addition to an injection molding process. Unlike injection molding processes which generally require cavities, such as compartments 58, to define a small draft to allow for the release of the part from the mold, blow molding processes can more easily produce cavities with interior walls which are oriented perpendicular to an opening.

As mentioned above, the illustrated magnet holders 72 have one open end 62a and one closed end 62b. This makes magnet holders 72 well suited for positioning at the end of a slot 28 when the slot 28 receives two or more holders. For example, FIG. 10 illustrates how two magnet holders 72 can be positioned with their open ends 62b facing each other and their closed ends 62a facing outwardly. This arrangement is well adapted for rotors having two magnet holders 72 in each slot 28.

As also evident from the figures, magnet holders 60 differ from magnet holders 72 in that the magnet bodies 56 mounted within magnet holders 60 will directly engage slot surface 36a which is positioned on the stator-side of slot 28 with a rear wall of magnet holder 60 being positioned between magnet body 56 and slot surface 36b. In this arrangement, the only dielectric material positioned between magnetic material 40 and the near side 36a of slot 28 would be the outer coating 54, provided that coating 54 were formed out of a dielectric material. In such an embodiment, both the outer layer 54 and a layer of dielectric material formed by magnet holder 60 is positioned between magnetic material 40 and far side 36b of slot 28. By providing a greater thickness of dielectric material between magnetic material 40 and the slot surface on one side of the slot than the other, the magnetic material 40 can be positioned relatively close to near side 36a of slot 28 which, as described above, is generally beneficial in terms of the performance of electric machine 20. In contrast, magnet holder 72 completely surrounds magnetic material 40 and will have a wall 76 that is disposed between magnetic material 40 and near side 36a of slot 28.

Although it will generally be advantageous to position the thinner thickness of dielectric material between the magnetic material 40 and the near side 36a of slot 28, this positioning can also be reversed if it is desirable in a particular application. It is also noted that the thickness of the dielectric material between the magnetic material 40 and the slot wall includes the outer layer 54, if this coating is formed out of a dielectric material, and any portion of the magnet holder 60 positioned between the magnetic material 40 and the slot wall. In some circumstances, where the magnet holder does not completely encircle the magnet body 56 and the magnet body directly engages the interior surface of the slot, the thickness of the dielectric material will be determined solely by whether or not the outer coating 54 is a dielectric material and the thickness of the outer coating 54.

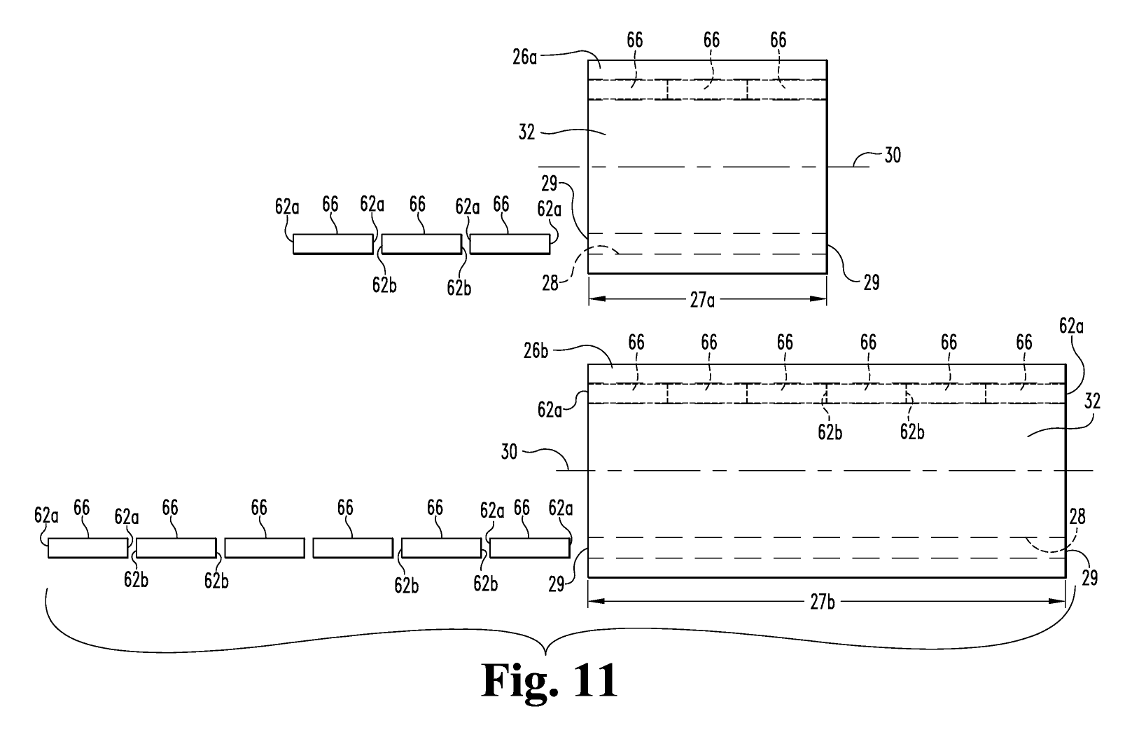

A method of manufacturing electric machines utilizing magnet holders in accordance with the present invention will now be discussed with reference to FIG. 11. The equipment necessary to manufacture stators 22 and rotors 26 are relatively expensive capital equipment which are typically limited to the production of a rotor or stator cross section which cannot be significantly varied for different models of electrical machines. Although the cross sectional configuration of the stators and rotors cannot be easily modified, such equipment oftentimes can be used to manufacture electrical machines 20 having a common cross sectional configuration but different axial lengths to thereby produce electrical machines 20 having different properties. Magnet holders in accordance with the present invention can facilitate the efficient manufacture of different axial length rotors 26a, 26b having a common cross sectional configuration.

Because rotors 26a, 26b have slots 28 with the same configuration and dimensions (except for differing axial lengths 27a, 27b), the same magnet holder assemblies can be used with each of the rotors 26a, 26b. The use of common parts for different models of electrical machines can help to reduce parts inventory and thereby facilitate to the efficient manufacture of such electrical machines.

In some situations it may be desirable to use a common configuration of magnet holder assemblies for all of the magnet holder assemblies installed in the slots 28 of both rotors 26a, 26b. This approach could be used to minimize the number of different parts needed to manufacture rotors 26a, 26b. Alternatively, it may be desirable to use more than one design of magnet holder assemblies in the manufacture of rotors 26a, 26b. For example, it may be desirable to use magnet holder assemblies 66 with a closed ends 62a at the opposite axial ends of slots 28 and use magnet holder assemblies 66 with open ends 62b for those assemblies which are not located at the axial ends of slots 28 as exemplified in FIG. 11.

While this invention has been described as having an exemplary design, the present invention may be further modified within the spirit and scope of this disclosure. This application is therefore intended to cover any variations, uses, or adaptations of the invention using its general principles.

What is claimed is:

1. An electric machine comprising:
a stator;
a rotor operably coupled with said stator; said rotor defining a body rotatable about an axis and having at least one axially extending slot, said at least one slot defining a slot volume;
a magnetic material forming at least one magnet body; and
at least one magnet holder, said magnet body being mounted within said magnet holder to form a magnet holder assembly and said magnet holder assembly being disposed within said slot and substantially filling the entire slot volume.

2. The electric machine of claim 1 wherein said magnet holder assembly is non-adhesively secured within said slot.

3. The electric machine of claim 2 wherein said magnet body is adhesively secured to said magnet holder.

4. The electric machine of claim 2 wherein said magnet body is secured to said magnet holder by frictional engagement between said magnet body and said magnet holder.

5. The electric machine of claim 1 wherein said at least one slot has a plurality of magnet holder assemblies disposed therein and wherein said at least one magnet body comprises a plurality of magnet bodies with at least one of said magnet bodies disposed in each of said plurality of magnet holders.

6. The electric machine of claim 5 wherein said plurality of magnet holder assemblies disposed in said at least one slot are positioned in an axially abutting arrangement and wherein said plurality of magnet holder assemblies define opposing magnet holder end walls disposed at opposite axial ends of said rotor body which each substantially cover an axial end surface of a respective one of said magnet bodies.

7. The electric machine of claim 6 wherein each of said magnet holder assemblies define opposing axial end surfaces and wherein each of said axial end surfaces of said magnet holder assemblies that are in axial abutment with one of said axial end surfaces of another one of said magnet holder assemblies is at least partially defined by one of said magnet bodies.

8. The electric machine of claim 1 wherein said at least one magnet body comprises a plurality of magnet bodies and said at least one magnet holder defines a plurality of discrete magnet holding compartments, each of said magnet holding compartments having a separate one of said magnet bodies disposed therein.

9. The electric machine of claim 1 wherein said magnet holder comprises first and second materials, said second material defining at least a portion of an exterior surface of said magnet holder engaged with an interior surface of said slot, said second material is a resiliently compressible material having a lower durometer value than said first material and wherein said second material is compressibly engaged by said interior surface of said slot to secure said magnet holder within said slot.

10. The electric machine of claim 1 wherein said at least one slot defines an elongate opening with two opposing major sides and two opposing edges extending between said major sides, said two opposing major sides defining a first side relatively proximal said stator and a second side relatively distal said stator, said magnet holder defining a first dielectric material thickness disposed between said first side of said slot and said magnetic material and a second dielectric material thickness disposed between said second side of said slot and said magnetic material wherein said first thickness is thinner than said second thickness.

11. The electric machine of claim 10 wherein said magnet body directly engages said rotor body along said first side of said slot.

12. The electric machine of claim 1 wherein said at least one slot defines at least one end region and said magnet holder defines at least one corresponding enlarged end positioned in said end region of said slot and thereby filling said end region of said slot with dielectric material.

13. An electric machine comprising:
a stator;
a rotor operably coupled with said stator, said rotor defining a body rotatable about an axis and having at least one axially extending slot, said at least one slot defining an axial length, said rotor body circumscribing at least a substantial majority of said slot in a plane oriented perpendicular to said axis over substantially the entire axial length of said slot and wherein said at least one slot defines an elongate opening with two opposing major sides, said two opposing major sides defining a first side disposed relatively proximal said stator and a second side disposed relatively distal said stator;
a magnetic material forming at least one magnet body; and
at least one magnet holder, said magnet body being mounted within said magnet holder to form a magnet holder assembly, said magnet holder assembly being disposed within said slot wherein said magnet holder assembly defines a greater thickness of dielectric material between said magnetic material and one of said first and second sides of said slot than between said magnetic material and the other of said first and second sides of said slot.

14. The electric machine of claim 13 wherein said magnet holder defines a greater thickness of dielectric material between said magnetic material and said second side of said slot than between said magnetic material and said first side of said slot.

15. The electric machine of claim 14 wherein said magnet body directly engages said rotor body along said first side of said slot.

16. The electric machine of claim 15 wherein said magnet body includes a layer of dielectric material covering said magnetic material.

17. The electric machine of claim 13 wherein said at least one slot has a plurality of magnet holder assemblies disposed therein in an axially abutting arrangement and wherein said at least one magnet body comprises a plurality of magnet bodies with at least one of said magnet bodies disposed in each of said plurality of magnet holders; and
wherein each of said plurality of magnet holder assemblies define opposing axial end surfaces; said axial end surfaces defining magnet holder end walls at opposite axial ends of said rotor body which substantially cover an axial end surface of a respective one of said magnet bodies and wherein each of said axial end surfaces of said magnet holder assemblies that are in axial abutment with one of said axial end surfaces of another one of said magnet holder assemblies is at least partially defined by a respective one of said magnet bodies.

18. The electric machine of claim 12 wherein said magnet holder assembly is non-adhesively secured within said slot.

19. The electric machine of claim 18 wherein said magnet holder comprises first and second materials, said second material defining at least a portion of an exterior surface of said magnet holder engaged with an interior surface of said slot, said second material being a resiliently compressible material having a lower durometer value than said first material and wherein said second material is compressibly engaged by said interior surface of said slot to secure said magnet holder within said slot.

20. An electric machine comprising:
a stator;
a rotor operably coupled with said stator, said rotor defining a body rotatable about an axis and having at least one axially extending slot, said at least one slot defining an axial length wherein said rotor body circumscribes at least a substantial majority of said slot in a plane oriented perpendicular to said axis over substantially the entire axial length of said slot;
a magnetic material forming at least one magnet body; and
a plurality of magnet holders, at least a portion of said magnet body being mounted within each of said plurality of magnet holders to form a plurality of magnet holder assemblies and wherein each of said at least one slots has a plurality of said magnet holder assemblies disposed therein.

21. The electric machine of claim 20 wherein said at least one magnet body comprises a plurality of magnet bodies and each of said plurality of magnet holders has at least one of said plurality of magnet bodies mounted therein and said plurality of magnet holders are disposed in said slot in an axially abutting arrangement.

22. The electric machine of claim 20 wherein said plurality of magnet holder assemblies define opposing magnet holder end walls disposed at opposite axial ends of said rotor body, each of said opposing end walls substantially covering an axial end surface of a respective one of said magnet bodies.

23. The electric machine of claim 20 wherein each of said magnet holder assemblies define opposing axial end surfaces and wherein each of said axial end surfaces of said magnet holder assemblies that are in axial abutment with one of said axial end surfaces of another one of said magnet holder assemblies is at least partially defined by a respective one of said magnet bodies.

24. The electric machine of claim 20 wherein said at least one slot defines an elongate opening with two opposing major sides and two opposing edges extending between said major sides, said two opposing major sides defining a first side relatively proximal said stator and a second side relatively distal said stator, each of said magnet holder assemblies defining a first dielectric material thickness disposed between said first side of said slot and said magnetic material and a second dielectric material thickness disposed between said second side of said slot and said magnetic material and wherein said first thickness is thinner than said second thickness.

25. The electric machine of claim 24 wherein said magnet bodies directly engage said rotor body along said first side of said slot.

26. The electric machine of claim 20 wherein said magnet holder assemblies are each non-adhesively secured within said at least one slot.

27. The electric machine of claim 26 wherein each of said magnet holders comprises first and second materials, said second material defining at least a portion of an exterior surface of each of said magnet holders engaged with an interior surface of said slot, said second material being a resiliently compressible material having a lower durometer value than said first material and wherein said second material of each of said magnet holders is compressibly engaged by said interior surface of said slot to secure said magnet holders within said slot.

28. The electric machine of claim 26 wherein said magnet holder assemblies substantially fill the entire volume of said slot.

29. An electric machine comprising:
a stator;
a rotor operably coupled with said stator; said rotor defining a body rotatable about an axis and having at least one axially extending slot;
a magnetic material forming at least one magnet body; and
at least one magnet holder, said magnet body being mounted within said magnet holder to form a magnet holder assembly, said magnet holder comprising first and second materials, said second material defining at least a portion of an exterior surface of said magnet holder assembly, said second material being a resiliently compressible material having a lower durometer value than said first material and wherein said second material is compressibly engaged by an interior surface of said slot to secure said magnet holder assembly within said slot.

30. The electric machine of claim 29 wherein said first material forms a substantial majority of said magnet holder and said second material forms an exterior layer about a selected portion of said magnet holder.

31. The electric machine of claim 30 wherein said at least one slot defines an elongate opening with two opposing major sides and two opposing edges extending between said major sides, said two opposing major sides defining a first side relatively proximal said stator and a second side relatively distal said stator, said exterior layer of second material being engaged with at least a portion of each of said two opposing edges and said second side.

32. The electric machine of claim 31 wherein said at least one slot defines a slot volume and said magnet holder assembly substantially fills the entire slot volume.

33. The electric machine of claim 32 wherein both of said first and second materials are dielectric materials and wherein said magnet holder assembly defines a greater thickness of dielectric material between said magnetic material and said second side of said slot than between said magnetic material and said first side of said slot.

34. The electric machine of claim 30 wherein said first material forms a first registry surface on said exterior surface of said magnet holder and wherein said first registry surface directly engages a portion of said interior surface of said slot defining a second registry surface when said magnet holder assembly is installed in said slot, engagement of said first and second registry surfaces controllably positioning said magnet holder assembly within said slot.

35. The electric machine of claim 34 wherein said magnet holder defines a pair of first registry surfaces, each of said first registry surfaces extending between opposing axial ends of said magnet holder and wherein said rotor body defines a pair of said second registry surfaces engageable with said pair of first registry surfaces, said pair of second registry surfaces extending an axial length of said slot, and wherein said slot defines an elongate opening and said pair of second registry surfaces are disposed proximate opposite lateral ends of said elongate opening.

36. A method of assembling electrical machines, said method comprising:
providing a first stator and a first rotor to manufacture a first electrical machine having a first axial length;
providing a second stator and a second rotor to manufacture a second electrical machine having a second axial length greater than the first axial length and wherein the first and second rotors have a substantially common cross sectional configuration defining at least one commonly shaped slot extending the axial length of the first and second rotors;
providing a plurality of first magnet holders each having at least one magnet body mounted therein to form a plurality of first magnet holder assemblies, each of the first magnet holder assemblies having a common configuration;
installing at least one of the first magnet holder assemblies in the commonly shaped slot of the first rotor and in the commonly shaped slot of the second rotor;
providing at least one second magnet holder having at least one magnet body mounted therein to form a second magnet holder assembly; and
installing the second magnet holder assembly in the commonly shaped slot of the second rotor.

37. The method of claim 36 wherein the at least one commonly shaped slots of the first and second rotors define first and second slot volumes and wherein the magnet holder assemblies substantially fill the entirety of the first and second slot volumes.

38. The method of claim 37 wherein each of the magnet holder assemblies disposed in the commonly shaped slots of the first and second rotors are non-adhesively secured therein by frictional engagement.

39. The method of claim 36 wherein the second magnet holder assembly has the same configuration as the first magnet holder assemblies.

40. The method of claim 36 wherein each of the magnet holders installed in the commonly shaped slots of the first and second rotors comprises first and second materials wherein the second material is a resiliently compressible material having a lower durometer value than said first material and wherein the second material defines at least a portion of an exterior surface of the magnet holder; said method further comprising:
engaging the second material of each of the magnet holders disposed in the commonly shaped slots of the of the first and second rotors with an interior surface of a respective one of the slots to compressibly engage the second material with the respective interior surface and thereby secure each of the magnet holders within a respective one of the commonly shaped slots.

41. The method of claim 40 wherein the first material of each of the magnet holders defines a first registry surface on the exterior surface of each of the magnet holders and wherein the interior surface of each of the commonly shaped slots of the first and second rotors defines an axially extending second registry surface and wherein during the installation of each of the magnet holders into one of the slots, the method further comprises engaging the first registry surface on the magnet holder with the second registry surface to controllably position the magnet holder within the slot.

42. The method of claim 36 wherein the commonly shaped slots of the first and second rotors each define an elongate opening with two opposing major sides and two opposing edges extending between the major sides, the two opposing major sides of each slot defining a first side relatively proximal the stator and a second side relatively distal the stator, and wherein said method further comprises:
directly engaging the magnet bodies disposed in the magnet holders installed within the commonly shaped slots of the first and second rotors with the rotor body along the first side of each commonly shaped slot.
